(19) United States
(12) Patent Application Publication
(10) Pub. No.: US 2009/0320209 A1
(43) Pub. Date: Dec. 31, 2009

(54) FOAM PAD HAVING ADHERED SPACER LAYER

(75) Inventor: Ricky McCain, Monroe, NC (US)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: PERFECT FIT INDUSTRIES, Charlotte, NC (US)

(21) Appl. No.: 12/431,247

(22) Filed: Apr. 28, 2009

Related U.S. Application Data
(60) Provisional application No. 61/048,266, filed on Apr. 28, 2008.

(51) Int. Cl. A47G 9/10; B32B 3/26; A47C 31/00

(52) U.S. Cl. 5/636; 428/304.4; 5/500

(57) ABSTRACT

A pad includes a first layer of material having a first main surface. A second layer of material includes a first surface, a second surface, and an intermediate spacer portion disposed therebetween. The second surface is adhered to at least a portion of the first main surface of the first layer of material. A mattress pad and a pillow having similar characteristics are also disclosed.

### CROSS-REFERENCE TO RELATED APPLICATIONS

This application claims the benefit of U.S. Provisional Patent Application No. 61/048,266, filed Apr. 28, 2008, entitled “Foam Pad Having Adhered Spacer Layer,” the entire contents of which are incorporated by reference herein.

### BACKGROUND OF THE INVENTION

Embodiments of the present invention relate generally to foam pads for use in mattress pads, pillows, or the like, and more particularly to such foam pads having a spacer layer adhered thereto.

Foam mattress pads and pillows, such as those formed of urethane foam, latex foam, and the like, are generally known in the art.

Memory foam has become popular in recent years, particularly for the bedroom furnishings industry. Memory foam is well-known and results from the combining of polyurethane foam with certain additives. The additives increase the density of the foam, thereby increasing its viscoelasticity. The resultant foam conforms to the shape of an object when the object exerts pressure onto the foam. However, the memory foam slowly returns to its original shape once the pressure is removed.

The technology has been applied to mattresses and mattress pads for beds. The memory foam conforms to the shape of the body of an individual resting in bed, minimizing pressure points on the body seen with stiffer mattresses or pads. Similarly, memory foam has been used for pillows to properly support the head and neck during sleep.

Unfortunately, the high density of foams, particularly memory foams, generally prevents proper ventilation of the material. As a result, the foam material can exhibit an uncomfortable level of heat to the user after a duration. Additionally, memory foam can retain a high level of moisture, further causing discomfort to the user and potentially leading to foul odors.

It is therefore desirable to manufacture a memory foam pad having adequate ventilation while retaining the above-described advantages of the foam's viscoelastic properties.

### BRIEF SUMMARY OF THE INVENTION

Briefly stated, various embodiments of the present invention comprise a pad including a first layer of material having a first main surface. A second layer of material includes a first surface, a second surface, and an intermediate spacer portion disposed therebetween. The second surface is adhered to at least a portion of the first main surface of the first layer of material.

Further embodiments of the present invention comprise a mattress pad including a first layer of material having a first main surface. A second layer of material includes a first surface, a second surface, and an intermediate spacer portion disposed therebetween. The second surface is adhered to at least a portion of the first main surface of the first layer of material.

Still further embodiments of the present invention comprise a pillow including a first layer of material having a first main surface. A second layer of material includes a first surface, a second surface, and an intermediate spacer portion disposed therebetween. The second surface is adhered to at least a portion of the first main surface of the first layer of material.

### BRIEF DESCRIPTION OF THE DRAWINGS

The foregoing summary, as well as the following detailed description of preferred embodiments of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

FIG. 1A is a perspective view of a pad in accordance with preferred embodiments of the present invention;

FIG. 1B is a greatly enlarged partial top plan view of the pad of FIG. 1A;

FIG. 2 is an enlarged partial elevational cross-sectional view of the pad of FIG. 1A;

FIG. 3 is a perspective view of a mattress pad in accordance with certain preferred embodiments of the present invention; and

FIG. 4 is a side elevational view of a pillow in accordance with certain preferred embodiments of the present invention.

### DETAILED DESCRIPTION OF THE INVENTION

Certain terminology is used in the following description for convenience only and is not limiting. The words “right”, “left”, “lower”, and “upper” designate directions in the drawings to which reference is made. The words “inwardly” and “outwardly” refer to directions toward and away from, respectively, the geometric center of the pad and designated parts thereof. The terminology includes the above-listed words, derivatives thereof, and words of similar import. Additionally, the words “a” and “an”, as used in the claims and in the corresponding portions of the specification, mean “at least one.”

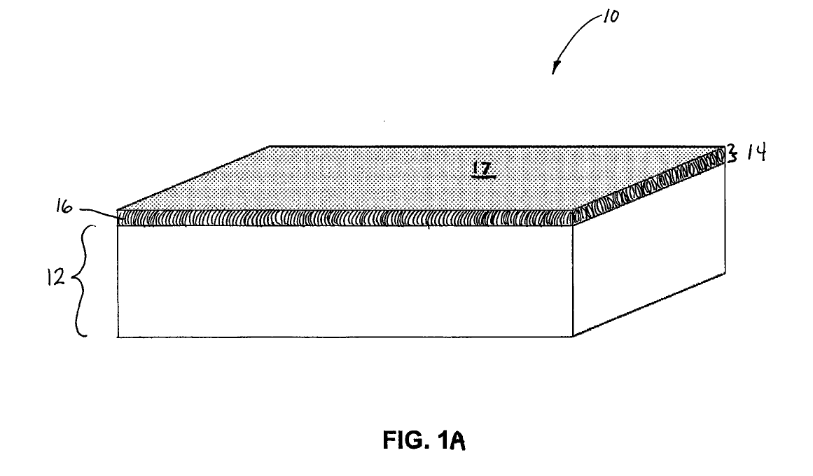

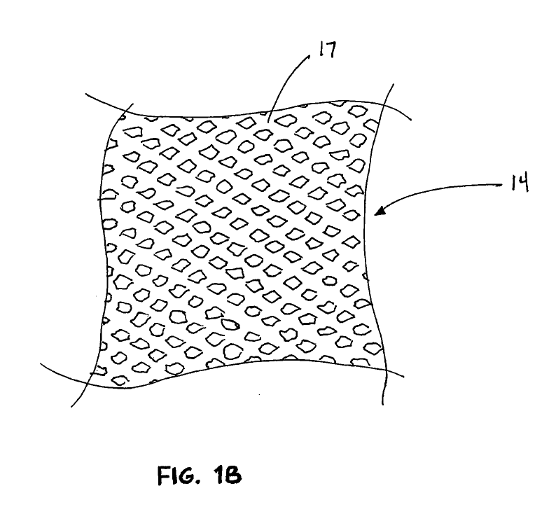

Referring to the drawings in detail, wherein like reference numerals indicate like elements throughout, there is shown in FIG. 1A a first preferred embodiment of a pad 10 having a first material layer 12 and a second material layer 14. The first material layer 12 is preferably a layer of foam, and more preferably, comprises a foam exhibiting viscoelastic properties, such as a memory foam. The first material layer 12 may also be made from a urethane foam, a latex foam, or the like.

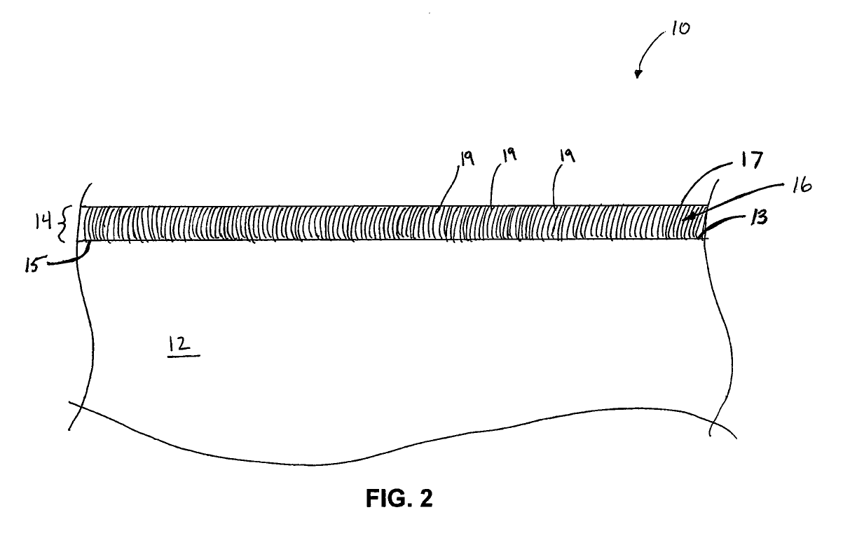

The second material layer 14 includes a first surface 17, a second surface 15 (FIG. 2), and an intermediate spacer portion 16 disposed therebetween. The first surface 17 (FIG. 1B) and the second surface 15 (which may be similar to the first surface 17 in FIG. 1B) are preferably arranged having a honeycomb-shape pattern, although other patterns may be used. The second material layer 14 is preferably comprised of 100% polyester, although other resilient materials may be used. In preferred embodiments, the second material layer is about ⅛ inches (in.) thick. However, the thickness may be changed according to the level of ventilation required, comfort of the user, or the like.

Referring to FIG. 2, the intermediate spacer portion 16 of the second material layer 14 preferably comprises a plurality of spaced apart fibers 19 extending between the first and second surfaces 17, 15. The fibers 19 provide a resilience such that when pressure is applied to the first surface 17, the first surface 17 is prevented from contacting the second surface 15 and closing the ventilation space. Preferably, the spaced apart fibers 19 extend generally longitudinally between the first and second surfaces 17, 15 such that each of the spaced apart fibers 19 are generally normal with respect to at least one of the first and second surfaces 17, 15. The fibers 19 thus maintain an airway to provide adequate ventilation between the first material layer 12 and the user when contacting the pad 10. Other arrangements in the intermediate spacer portion 16 may also be utilized in order to maintain an air gap between the first and second surfaces 17, 15, such as spaced apart clusters of fibers, or the like.

The first material layer 12 includes a first main surface 13. The second surface 15 of the second material layer 14 may be directly adhered to the first main surface 13 of the first material layer 12. The second material layer 14 may be adhered by heat or flame lamination, in which the first main surface 13, the second surface 15, or both the first main surface 13 and the second main surface 15 are heated to form a thin layer of molten polymer. The first and second material layers 12, 14 are then brought together under pressure, and as the polymer layer cools a bond is formed between the first main surface 13 and the second surface 15. Of course, other known means of attaching the first and second material layers 12, 14 may be utilized such as using adhesives, epoxies, double-sided tape, and the like.

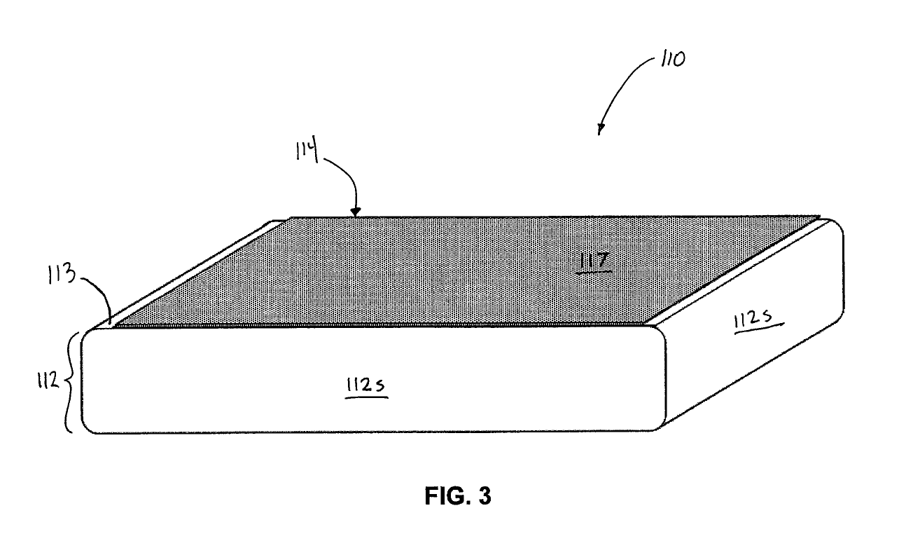

FIG. 3 shows a mattress pad 110 in accordance with preferred embodiments of the present invention. The mattress pad 110 is shown having a conventional rectangular shape, but any shape may be used, such as a circle, oval, or the like. The mattress pad 110 in FIG. 3 has a first material layer 112 of thick foam with a first (top) main surface 113. The second material layer 114 is adhered to a major portion of the top surface 113. The second material layer 114 may cover more or less of the top surface 113, and may even extend to sides 112s of the first material layer 112. Optionally, the second material layer 114 may also be adhered to an underside (not shown) of the first material layer 112. The user lies on the mattress pad 110 atop a first surface 117 of the second material layer 114. Therefore, the second material layer 114 should preferably be adhered to at least the portion of the top surface 113 that would receive the body of the user.

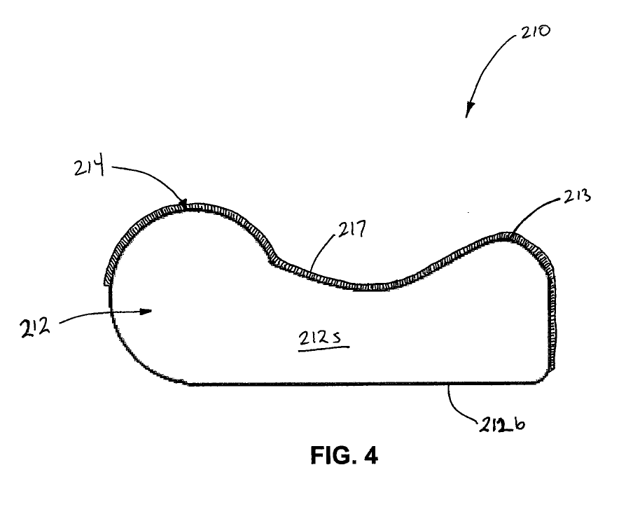

FIG. 4 shows a pillow 210 in accordance with preferred embodiments of the present invention. The pillow 210 in FIG. 4 has a first material layer 212 of a thick foam with a first (top) main surface 213. The top surface 213 in FIG. 4 is contoured for supporting the head and neck of the user, but any shape may be used for the pillow 210, such as boxes, cylinders, or the like. The second material layer 214 is adhered to the top surface 213, but may cover more or less of the top surface 214 and may extend to the sides 212s or bottom surface 212b of the first material layer 212. This may be especially true for pillows 210 that are intended for use on multiple sides or symmetrically shaped pillows 210, such as rectangular or cylinder shaped. The head of the user is placed atop a first surface 217 of the second material layer 214. Therefore, the second material layer 214 should preferably be adhered to at least the portion of the top surface 213 intended to receive the head of the user.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I claim:

1. A pad comprising:
(a) a first layer of material having a first main surface; and
(b) a second layer of material having a first surface, a second surface, and an intermediate spacer portion disposed therebetween, the second surface being adhered to at least a portion of the first main surface of the first layer of material.

2. The pad of claim 1, wherein the intermediate spacer portion includes a plurality of spaced-apart fibers extending between the first and second surfaces of the second material layer.

3. The pad of claim 2, wherein the second material layer comprises polyester.

4. The pad of claim 1, wherein the first material layer comprises a foam.

5. The pad of claim 4, wherein the foam is one of memory foam, urethane foam, and latex foam.

6. The pad of claim 1, wherein the second surface of the second material layer is adhered to the at least a portion of the first main surface of the first material layer by heat lamination.

7. A mattress pad comprising:
(a) a first layer of material having a first main surface; and
(b) a second layer of material having a first surface, a second surface, and an intermediate spacer portion disposed therebetween, the second surface being adhered to at least a portion of the first main surface of the first layer of material.

8. The mattress pad of claim 7, wherein the intermediate spacer portion includes a plurality of spaced-apart fibers extending between the first and second surfaces of the second material layer.

9. The mattress pad of claim 8, wherein the second material layer comprises polyester.

10. The mattress pad of claim 7, wherein the first material layer comprises a foam.

11. The mattress pad of claim 10, wherein the foam is one of memory foam, urethane foam, and latex foam.

12. The mattress pad of claim 7, wherein the second surface of the second material layer is adhered to the at least a portion of the first main surface of the first material layer by heat lamination.

13. A pillow comprising:
(a) a first layer of material having a first main surface; and
(b) a second layer of material having a first surface, a second surface, and an intermediate spacer portion disposed therebetween, the second surface being adhered to at least a portion of the first main surface of the first layer of material.

14. The pillow of claim 13, wherein the intermediate spacer portion includes a plurality of spaced-apart fibers extending between the first and second surfaces of the second material layer.

15. The pillow of claim 14, wherein the second material layer comprises polyester.

16. The pillow of claim 13, wherein the first material layer comprises a foam.

17. The pillow of claim 16, wherein the foam is one of memory foam, urethane foam, and latex foam.

18. The pillow of claim 13, wherein the second surface of the second material layer is adhered to the at least a portion of the first main surface of the first material layer by heat lamination.
